(19) United States
(12) Patent Application Publication
(10) Pub. No.: US 2013/0289200 A1
(43) Pub. Date: Oct. 31, 2013

(54) NOVEL HYDROPHILIC CHAIN TRANSFER AGENT AND END-MODIFIED STYRENE-BUTADIENE COPOLYMER USING THEM

(71) Applicants: KOREA KUMHO PETROCHEMICAL CO., LTD., Seoul (KR); INSTITUTE FOR RESEARCH & INDUSTRY COOPERATION, PN, Busan (KR)

(72) Inventors: Gwang Hoon Kwag, Daejeon (KR); Jong Yeop Lee, Busan (KR); Dong Hyuk Na, Daejeon (KR); Jun Keol Choi, Daejeon (KR); Hyun Jong Paik, Busan (KR); Bong Soo Kim, Busan (KR); Hee Jeong Kim, Ulsan (KR)

(73) Assignees: Institute for Research & Industry Cooperation, PNU, Busan (KR); Korea Kumho Petrochemical Co., Ltd., Seoul (KR)

(21) Appl. No.: 13/625,106

(22) Filed: Sep. 24, 2012

(30) Foreign Application Priority Data
Apr. 27, 2012 (KR) 10-2012-0044945

(51) Int. Cl. C08F 120/18; C08K 3/36; C08L 33/12; C08F 265/04

(52) U.S. Cl. 524/560; 526/329.7; 525/308

(57) ABSTRACT

Disclosed are a novel chain transfer agent having a trichloromethyl functional group bonded at an end thereof, an end-modified styrene-butadiene copolymer prepared by using the chain transfer agent, and an organic-inorganic composite obtained by mixing the end-modified styrene-butadiene copolymer with silica. The disclosed end-modified styrene-butadiene copolymer has a high affinity with silica because its end is modified with a hydrophilic chain transfer agent. Thus, the organic-inorganic composite including the mixture of the copolymer with silica is useful as a material for the manufacture of rubber products such as a tire, a sole, a rubber hose, or a rubber belt.

### CROSS-REFERENCE TO RELATED APPLICATION

This application claims under 35 U.S.C. §119(a) the benefit of Korean Patent Application No. 10-2012-0044945 filed on Apr. 27, 2012, the entire contents of which are incorporated herein by reference.

### BACKGROUND

(a) Technical Field

The present invention relates to a novel hydrophilic chain transfer agent having a trichloromethyl functional group bonded at an end thereof, a styrene-butadiene copolymer end-modified with the chain transfer agent, and an organic-inorganic composite obtained by mixing the end-modified styrene-butadiene copolymer with silica.

(b) Background Art

A styrene-butadiene copolymer (SBR) can be divided into an emulsion polymerization styrene-butadiene copolymer (E-SBR), and a solution polymerization styrene-butadiene copolymer (S-SBR) according to the method of its preparation. The emulsion polymerization styrene-butadiene copolymer (E-SBR), as a first generation tire material, was used in an amount of 5,000,000 tons or more annually, while being mixed with carbon black as a reinforcing agent. However, the E-SBR has a high affinity with carbon black, but has a low affinity with silica. Thus, it has a limitation in being applied as a high fuel efficiency silica tire material. Accordingly, in order to improve fuel efficiency, as a second generation tire material using a silica reinforcing agent, a solution polymerization styrene-butadiene copolymer (S-SBR) has been mainly used.

The solution polymerization styrene-butadiene copolymer (S-SBR) is produced by anionic solution polymerization. In the S-SBR produced by the anionic solution polymerization, the polymer can be end-modified. Thus, the S-SBR has an advantage in that its end can be modified with a polar group such as a carboxyl group, thereby improving affinity with silica. Meanwhile, in its manufacturing process, solution polymerization, as compared to emulsion polymerization, productivity is low, energy consumption is high, and discharge of a volatile organic compound is unavoidable. Also, the S-SBR requires a higher production unit cost than the E-SBR. Thus, it is difficult to apply the S-SBR as a general medium-low price tire material.

Mainly in synthetic rubber manufacturers, studies to improve affinity with silica through introduction of a polar group into a chain of an emulsion polymerization styrene-butadiene copolymer (E-SBR) have been recently conducted. For example, U.S. Pat. Nos. 3,575,913 and 3,563,946 disclose a method of preparing a styrene-butadiene-acrylate copolymer by using potassium peroxodisulfate or azobis (isobutyronitrile)(AIBN) in an emulsified state. U.S. Pat. Nos. 5,274,027 and 5,302,655 disclose a technology of preparing a styrene-butadiene-acrylate-based copolymer by using an acrylate-based compound (such as itaconic acid, methyl methacrylate, etc.), and a polymerization initiator (such as ammonium persulfate, etc) through emulsion polymerization. U.S. Pat. Nos. 6,512,053 and 6,716,925 disclose a method of preparing a styrene-butadiene-acrylate-based copolymer by using a hydroxyacrylate-based compound, etc. (such as 2-hydroxyethyl methacrylate, 2-hydroxypropyl methacrylate, hydroxymethyl methacrylamide) as an acrylate-based compound, and using ammonium persulfate, etc. as a polymerization initiator through emulsion polymerization. As described above, in order to introduce a hydrophilic functional group into a main chain of a styrene-butadiene copolymer, it is required to perform emulsion polymerization of a styrene monomer, a butadiene monomer and a hydrophilic monomer. However, when hydrophilic monomers are diffused into an organic phase of micelles including styrene and butadiene, the diffusion rate is low. Thus, it is very difficult to increase the content of hydrophilic monomers within an emulsion copolymer chain. For example, a hydrophilic monomer such as acrylic acid has a very high polarity, and thus its diffusion rate from an aqueous phase into micelles is very low. Thus, it rather shows a tendency to cause homopolymerization within the aqueous phase.

As described above, there is still room for improvement in a technology of adding a hydrophilic monomer in improvement of affinity with silica through introduction of a polar group into a chain of an emulsion polymerization styrene-butadiene copolymer (E-SBR).

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

An object of the present invention is to provide a novel hydrophilic chain transfer agent having a chemical structure by which a hydrophilic monomer can be easily introduced into a chain of an emulsion polymerization styrene-butadiene copolymer (E-SBR).

Also, another object of the present invention is to provide a styrene-butadiene copolymer end-modified with the hydrophilic chain transfer agent.

Also, a further object of the present invention is to provide an organic-inorganic composite obtained by mixing the end-modified styrene-butadiene copolymer with silica.

In one aspect, the present invention provides a hydrophilic chain transfer agent represented by Formula 1 below.

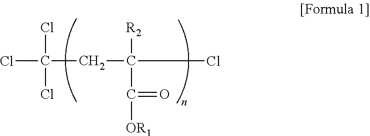

(In Formula 1, R₁ represents a hydrogen atom, a C1 to C8 straight, branched, cyclic alkyl group, a C1 to C8 hydroxyalkyl group, a C2 to C8 alkoxyalkyl group, or a benzyl group; R₂ represents a hydrogen atom, or a C1 or C3 straight, branched alkyl group; n represents an integer of 1 to 4,000.)

In another aspect, the present invention provides an end-modified styrene-conjugated copolymer, represented by Formula 2 below, which is prepared through emulsion polymerization of a styrene monomer, a butadiene monomer, and the hydrophilic chain transfer agent represented by Formula 1.

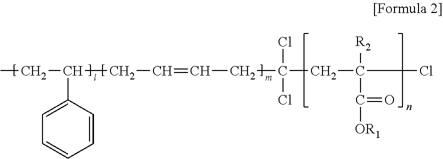

(In Formula 2, R₁ and R₂ are the same as those defined in Formula 1 above, and l+m=1, wherein l represents an integer of 0.15 to 0.5, and n represents an integer of 1 to 4,000.)

In still another aspect, the present invention provides an organic-inorganic composite obtained by mixing 100 parts by weight of the end-modified styrene-conjugated copolymer, represented by Formula 2 with 50 to 90 parts by weight of silica.

Other aspects and exemplary embodiments of the invention are discussed infra.

The above and other features of the invention are discussed infra.

The inventive hydrophilic chain transfer agent not only has a role as a molecular weight regulator for a polymer, but also can be easily dispersed into micelles during an emulsion polymerization process due to its chemical structure including an acrylate repeating unit structure and a trichloromethyl functional group bound at the end. Thus, it has an effect in that it allows an acrylate repeating unit structure to be easily introduced into an emulsion copolymer.

Also, the inventive emulsion polymerization styrene-butadiene copolymer (E-SBR) has a hydrophilic acrylate group introduced at the end of a polymer chain. This improves the copolymer's own polarity, thereby maximizing the copolymer's affinity with silica.

Also, the inventive organic-inorganic composite obtained by mixing the end-modified styrene-conjugated copolymer with silica is excellent in physical properties such as rolling resistance. When used as a tread material for an automobile tire, it reduces hysteresis, increases wet traction of the tire, and further improves wear resistance of the tire. Accordingly, the inventive organic-inorganic composite is usefully used in the preparation of rubber products such as tire, sole, rubber hose, or rubber belt, and is especially useful as tire material excellent in wear and wet-skid resistance and fuel efficiency characteristics.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows a molecular weight distribution curve on a chain transfer agent prepared from Preparation Examples 1 and 2; and

FIG. 2 shows a molecular weight distribution curve on an end-modified SBR copolymer prepared from Example 1 and Comparative Example 1.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention relates to a hydrophilic chain transfer agent having a trichloromethyl functional group bonded at an end thereof, an end-modified styrene-butadiene copolymer prepared by using the chain transfer agent, and an organic-inorganic composite obtained by mixing the end-modified styrene-butadiene copolymer with silica.

Hereinafter, the present invention will be described in more detail.

The hydrophilic chain transfer agent according to the present invention is a telomer represented by Formula 1 above. The hydrophilic chain transfer agent represented by Formula 1 is prepared by performing polymerization of acrylate-based monomer and carbon tetrachloride through an inert hydrocarbon solvent and a free radical initiator.

Herein, the acrylate-based monomer may be selected from the group including methyl methacrylate, methyl acrylate, ethyl methacrylate, ethyl acrylate, propyl methacrylate, propyl acrylate, n-butyl methacrylate, n-butyl acrylate, tert-butyl methacrylate, cyclohexyl methacrylate, benzyl methacrylate, methoxyethyl methacrylate, ethoxyethyl methacrylate, butoxymethyl methacrylate, hydroxyethyl acrylate, hydroxyethyl methacrylate and the like. Preferably, as the acrylate-based monomer, methyl acrylate, ethyl acrylate, methyl methacrylate, or ethyl methacrylate may be used.

As the hydrocarbon solvent, a C5 to 010 straight, branched, cyclic aliphatic hydrocarbon solvent, or a C6 to C15 aromatic hydrocarbon solvent may be used. Preferably; as the hydrocarbon solvent, hexane, heptane, cyclohexane, benzene, or toluene may be used.

As the free radical initiator, one or two kinds or more of conventional emulsion polymerization initiators used in the art, selected from the group including a peroxodisulfate-based (such as potassium peroxodisulfate), a peroxide-based (such as benzyl peroxide, dicumyl peroxide, methanehydro peroxide), an azo-based (such as 2,2′-azobis(isobutylamidine)dihydrochloride), a redox initiating system, and the like, may be used.

The hydrophilic chain transfer agent represented by Formula 1 prepared by polymerizing the acrylate-based monomer and the carbon tetrachloride has a weight-average molecular weight (Mw) (measured by gel-permeation chromatography (GPC)) ranging from 1,000 to 500,000 g/mol, and preferably from 1,000 to 20,000 g/mol. When the weight-average molecular weight of the hydrophilic chain transfer agent is greater than the above range, the agent is not helpful in silica dispersibility, and also has a disadvantageous effect on a chain transfer reaction.

Also, the end-modified styrene-butadiene copolymer represented by Formula 2 above, according to the present invention, has a structure in which the end of an emulsion polymerization styrene-butadiene copolymer (E-SBR) is modified with the hydrophilic chain transfer agent represented by Formula 1.

In consideration of the mechanistic characteristic of generally known emulsion polymerization, it is not easy to introduce a hydrophilic functional group into a chain of an E-SBR. However, in the present invention, since the hydrophilic Telomer represented by Formula 1 above is used as a chain transfer agent, it is possible to introduce a macro hydrophilic group into a polymer end.

The end-modified styrene-butadiene copolymer represented by Formula 2 above is prepared by emulsion polymerization conventionally used for preparing an emulsion polymerization styrene-butadiene copolymer (E-SBR). However, herein, as a chain transfer agent, the telomere represented by Formula 1 above is used. Specifically, the end-modified styrene-butadiene copolymer represented by Formula 2 above is prepared by emulsion-polymerization of 100 parts by weight of monomer mixture containing a styrene monomer and a butadiene monomer with addition of 0.01 to 5 parts by weight of chain transfer agent represented by Formula 1 above, 0.05 to 3 parts by weight of radical initiator, 0.1 to 10 parts by weight of emulsifier and the like. Also, the emulsion polymerization is performed at 0 to 70° C. for 4 to 48 hours. When the emulsion polymerization temperature is lower than 0° C., polymerization is not activated. On the other hand, when polymerization is performed at a high temperature condition of greater than 70° C., gel is formed. Thus, it is preferred that the above temperature range be maintained.

The monomer mixture used in the preparation of the styrene-butadiene copolymer includes 10 to 50 wt % of styrene monomer and 50 to 90 wt % of butadiene monomer. In the mixing ratio of the monomers, when the content of styrene monomers is relatively too low, mechanical physical properties such as tensile strength may be lowered. On the other hand, when the content of butadiene monomers is relatively too low, elasticity and wear resistance may be lowered. Thus, it is preferable to maintain the above mentioned monomer mixing ratio as much as possible. As the styrene monomer, styrene is generally used, but, alpha-methylstyrene, o-methylstyrene, p-methylstyrene, p-tert-butylstyrene, dimethylstyrene, vinyltoluene, vinylxylene, diphenylethylene and vinyl naphthalene may be used alone or in combination. As the butadiene monomer, 1,3-butadiene, chlorobutadiene or isoprene may be used alone or in combination.

The chain transfer agent is used to give hydrophilicity to the copolymer. Further, by adjusting the amount of the chain transfer agent, it is possible to adjust the weight-average molecular weight of the prepared copolymer. When the prepared styrene-butadiene copolymer has a weight-average molecular weight ranging from 100000 to 3000000, it is preferable to use the chain transfer agent represented by Formula 1 above in an amount of 0.01 to 5 parts by weight with respect to 100 parts by weight of monomer mixture.

As the radical initiator, a conventional emulsion polymerization initiator used in the art, selected from the components exemplified in the above chain transfer agent preparation method may be used. For example, as the radical initiator, one or two kinds or more selected from the group including a peroxodisulfate-based (such as potassium peroxodisulfate), a peroxide-based (such as benzyl peroxide, dicumyl peroxide, methanehydro peroxide), an azo-based (such as 2,2′-azobis(isobutylamidine)dihydrochloride), a redox initiating system, and the like, may be used. The radical initiator may be used in an amount of 0.05 to 3 parts by weight with respect to 100 parts by weight of monomer mixture. When the radical initiator is used in an amount of less than 0.05 parts by weight, the polymerization initiation efficiency may be reduced. On the other hand, when the radical initiator is used in an excessive amount of greater than 3 parts by weight, a low molecular weight copolymer may be produced.

As the emulsifier, one or two kinds or more selected from the group including anionic, cationic, and nonionic surfactants and the like may be used. Preferably, one or two kinds or more selected from the group including alkyl sulfate metal salt, alkylarylsulfonic acid metal salt, alkylphosphate metal salt, alkyl sulfate ammonium salt, alkylaryl sulfonic acid ammonium salt, alkylaryl sulfonic acid ammonium salt, aryl sulfonic acid ammonium salt, and alkyl phosphate ammonium salt may be used. Herein, the alkyl or aryl chain has 5 to 20 carbon atoms. When the number of the carbon atoms is less than 5 or greater than 20, a surface-activating force may be reduced. More preferably, a metal salt or an ammonium salt of acid selected from the group including dodecyl benzene sulfonic acid, rosin acid, fatty acid, lauryl sulfonic acid and hexadecyl sulfonic acid may be used. The emulsifier may be used in an amount of 0.1 to 10 parts by weight with respect to 100 parts by weight of monomer mixture. When the emulsifier is used in an amount of less than 0.1 parts by weight, micelles may be not formed, and on the other hand when the emulsifier is used in an amount of greater than 10 parts by weight, micro-emulsion may be formed, thereby producing a low molecular weight-copolymer. Thus, it is preferred that the emulsifier in the above mentioned range be used.

The end-modified styrene-butadiene copolymer represented by Formula 2 above prepared through emulsion polymerization under the above described condition is prepared into a powder with a particle size of 20 to 200 nm. Also, its weight-average molecular weight (Mw) ranges from 100,000 to 3,000,000 g/mol, and preferably ranges from 1,000,000 to 2,500,000 g/mol. When the weight-average molecular weight of the prepared end-modified styrene-butadiene copolymer is less than the above mentioned range, the physical property of the polymer may be lowered, and on the other hand, when the weight-average molecular weight is greater than the range, a gelation, and an excessive increase of viscosity may cause a problem in processability. Thus, it is preferable to prepare the copolymer in such a manner that it can have the above mentioned molecular weight range. Meanwhile, as described above, a physical property may vary according to the molecular weight of the prepared copolymer. Accordingly, according to application fields, the molecular weight of a copolymer to be prepared may be appropriately adjusted. Also as described above, the molecular weight of the styrene-butadiene copolymer can be sufficiently adjusted by the amount of the chain transfer agent represented by Formula 1 above. For example, in order to prepare a copolymer to be applied in a field requiring elasticity and high mechanical physical property, the styrene-butadiene copolymer is prepared in such a manner that it can have a molecular weight as high as possible. Also, in order to prepare a copolymer to be applied in a field requiring processability enhancement, the styrene-butadiene copolymer is prepared in such a manner that it can have a molecular weight as low as possible.

Also, the organic-inorganic composite according to the present invention is a silica composite including 100 parts by weight of end-modified styrene-butadiene copolymer represented by Formula 2 above and 50 to 90 parts by weight of silica.

The end-modified styrene-butadiene copolymer represented by Formula 2 above has a hydrophilic macro functional group at the end thereof, and thus is excellent in dispersibility and compatibility with silica. Accordingly, the inventive organic-inorganic composite may be used in the manufacturing field of rubber products such as a tire, a sole, a rubber hose, or a rubber belt, by replacing a rubber material. Especially, when the composite is applied as a tire material, due to the high silica-dispersibility, it is possible to not only to improve the wet traction characteristic, thereby improving an automobile braking performance but also to reduce rolling resistance, thereby improving the fuel efficiency characteristic of an automobile. In one example of Preparation Examples below, a conventional composition used in preparing a tread of an automobile tire includes a styrene-butadiene copolymer and silica. In other words, the tread composition for a tire may be prepared by adding 100 parts by weight of styrene-butadiene copolymer and 50 to 90 parts by weight of silica with conventional additives such as 1 to 10 parts by weight of zinc oxide, 1 to 10 parts by weight of stearic acid, 10 to 50 parts by weight of process oil, 1 to 10 parts by weight of bis(3-triethoxysilylpropyl) disulfide, 0.1 to 5 parts by weight of anti-oxidant, 0.1 to 5 parts by weight of sulfur, and 0.1 to 5 parts by weight of vulcanization accelerator. As can be found from the comparison in physical properties between test samples prepared in Preparation Examples below, the inventive organic-inorganic composite can satisfy all of physical properties required for a tire.

### EXAMPLES

The following Examples and Preparation Examples illustrate the invention and are not intended to limit the same.

### Preparation Example

### Preparation of a Chain Transfer Agent

### Preparation Examples 1 to 3

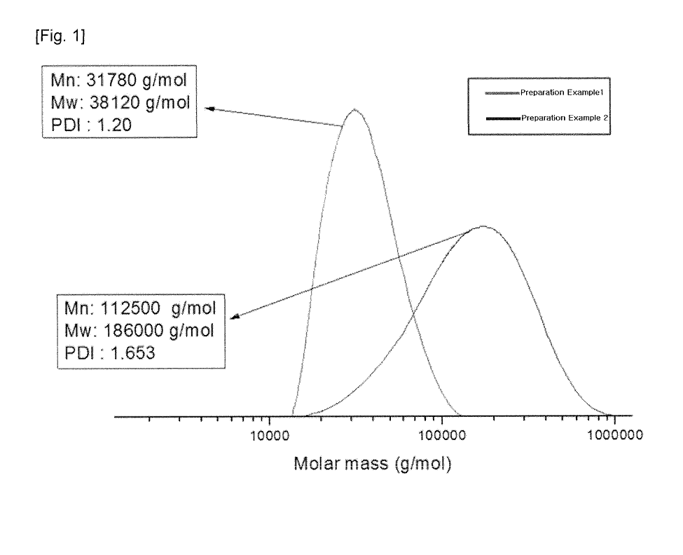

A 250 mL reactor was sequentially charged with benzene as a polymerization solvent, methyl methacrylate (MMA), and carbon tetrachloride (CCl₄), subjected to nitrogen substitution, and covered with a rubber cap. As a polymerization initiator, azobis (isobutyronitrile) (AlBN) 5×10⁻³ mole/L was quantitatively measured, dissolved in a benzene solvent, and injected by using a syringe. Then, following nitrogen substitution again, at 80° C., polymerization was performed. After the polymerization was finished, the resultant product was sufficiently purified by being immersed in methanol several times, and dried at room temperature for 2 days. Through gel-permeation chromatography (GPC), weight-average molecular weight was measured. The molecular weight distribution curve of the chain transfer agents prepared from Preparation Examples 1 and 2 is shown in FIG. 1.

TABLE 1

| | monomer composition | | | weight-average |
|---|---|---|---|---|
| | | [CCl₄]/[M], | reaction | molecular weight |
| index | monomer(M) | molar ratio | time | (g/mol) |
| Preparation | methyl | 5 | 3 h | 38,120 |
| Example 1 | methacrylate | | | |
| Preparation | methyl | 0.2 | 5 h | 186,000 |
| Example 2 | methacrylate | | | |
| Preparation | ethyl | 5 | 3 h | 42,500 |
| Example 3 | methacrylate | | | |

### Example

### Preparation of an End-Modified SBR Copolymer

### Examples 1 to 3 and Comparative Example 1

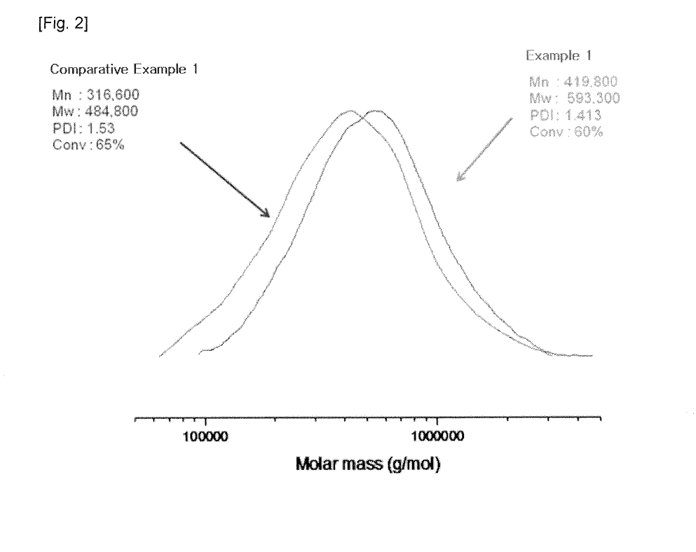

At 10° C., a 5 L pressure reactor was sequentially charged with water 1500 mL, sodium rosinate 25 g, sodium fatty acid 35 g, styrene 40 g, 1,3-butadiene 60 g, a chain transfer agent 5 g (noted in table 2 below), methane hydroperoxide 1.0 g, EDTA 0.5 g, and ferrous sulfate 0.1 g while the materials were stirred for 10 hours. Diethylhydroxyamine 1.0 g was introduced thereto to stop the reaction. For latex agglutination, 20 g of 20% sulfuric acid aqueous solution was introduced thereto. Then, through a stripping process and a drying process, an end-modified styrene-butadiene copolymer was prepared. The molecular weight was determined through gel-permeation chromatography (GPC). The molecular weight distribution curve of the end-modified SBR copolymers prepared from Example 1 and Comparative Example 1 is shown in FIG. 2.

TABLE 2

| | | | Example | | | Comp. |
|---|---|---|---|---|---|---|
| index | | | 1 | 2 | 3 | Exp. 1 |
| component | monomer | styrene | 40 | 40 | 40 | 40 |
| (g) | | 1,3-butadiene | 60 | 60 | 60 | 60 |
| | chain transfer | Preparation Example 1 | 0.5 | — | — | 5 |
| | agent | Preparation Example 2 | — | 0.5 | — | — |
| | | Preparation Example 3 | — | — | 0.5 | — |
| | | t-dodecylmercaptan | — | — | — | 0.5 |
| | emulsifier | sodium rosinate | 2.5 | 2.5 | 2.5 | 2.5 |
| | | sodium fatty acid | 3.5 | 3.5 | 3.5 | 3.5 |
| | polymerization | methane | 0.1 | 0.1 | 0.1 | 0.1 |
| | initiator | hydroperoxide | | | | |
| | | EDTA | 0.05 | 0.05 | 0.05 | 0.05 |
| | | ferrous sulfate | 0.01 | 0.01 | 0.01 | 0.01 |
| | polymerization | diethylhydroxyamine | 0.1 | 0.1 | 0.1 | 0.1 |
| | stopper | | | | | |

| | | | | |
|---|---|---|---|---|
| yield (%) | 68 | 60 | 61 | 62 |
| weight-average molecular weight (g/mol) | 593,000 | 580,000 | 565,000 | 484,800 |

As noted in table 2 above, in the styrene-butadiene copolymer, according to the present invention, prepared by using the hydrophilic chain transfer agent represented by Formula 1 through emulsion polymerization, a high yield was maintained due to stable emulsion formation, and the molecular weight of the copolymer can be easily adjusted.

### Reference Example

### Preparation of an Organic-Inorganic Composite

### Reference Examples 1 to 3 and Comparative Reference Examples 1 and 2

By using a composite including the copolymer prepared from any one of Examples 1 to 3 and Comparative Example 1, or a commercially available copolymer, and silica, a tread sheet for an automobile tire was prepared in the following method.

According to the composition ratio noted in table 3 below, copolymer 100 g, silica (Zeosil 175) 70 g, process oil 37.5 g, bis(3-triethoxysilylpropyl) disulfide (Degussa Co., Si69) 5.5 g, para-phenylenediamine (as anti-oxidant, Kumho Petrochemical, 6-PPD) 1 g, zinc oxide 3 g, and stearic acid 2 g were sequentially charged into an internal mixer (banbury mixer). At 120° C., at 60 rpm, for 6 min 30 sec, a first mixing step for kneading was performed, and then the processing temperature was cooled to 60° C. The first mixture was added with sulfur 2.2 g, and N-cyclohexyl-2-benzothiazylsulfonamide 2.8 g (as a vulcanization accelerator), and the materials were stirred and mixed at 60° C. at a rate of 50 rpm for 3 min so as to prepare a second mixture. Then, the resultant product was processed into a flat sheet form through a roll with a thickness of 2 mm, and left for 24 h. Then, in a vulcanization process, the flat sheet was pressed for 10 min by a hot press of 160° C. at a pressure of 160 kgf/cm² or more and thus was prepared into a test sample sheet (with a thickness of 2 mm) for physical property measurement.

On the prepared test sample, a physical property was measured, and is noted in table 3 below. Herein, the processability was measured by a compound Mooney viscosity (Compound ML), the tensile property was determined in accordance with ASTM D412, the wet-stop property was determined by hysteresis (tan δ), and the wear property was determined in accordance with DIN.

TABLE 3

| | | | Ref. Example | | | Comparative Ref. |
|---|---|---|---|---|---|---|
| index | | | 1 | 2 | 3 | Exp. 1 |
| component | copolymer | Example 1 | 100 | — | — | — |
| (g) | | Example 2 | — | 100 | — | — |
| | | Example 3 | — | — | 100 | — |
| | | Comparative | — | — | — | 100 |
| | | Example 1 | | | | |

| | | | | | |
|---|---|---|---|---|---|
| | silica | 70 | 70 | 70 | 70 |
| | process oil | 37.5 | 37.5 | 37.5 | 37.5 |
| | Si69 | 5.5 | 5.5 | 5.5 | 5.5 |
| | 6-PPD | 1.0 | 1.0 | 1.0 | 1.0 |
| | ZnO | 3 | 3 | 3 | 3 |
| | stearic acid | 2 | 2 | 2 | 2 |
| | sulfur | 2.2 | 2.2 | 2.2 | 2.2 |
| | vulcanization | 2.8 | 2.8 | 2.8 | 2.8 |
| | accelerator | | | | |
| Processability | Comp ML (1 + 4, 100° C.) | 124 | 131 | 118 | 111 |
| tensile | Hardness (Shore A) | 68 | 69 | 66 | 65 |
| physical | M-300% (kgf/cm²) | 198 | 195 | 193 | 175 |
| property | T.S. (kgf/cm²) | 230 | 221 | 226 | 174 |
| | E.B. (%) | 450 | 434 | 448 | 325 |
| dynamic | Tg, ° C. | 5.4 | −5.7 | 6.1 | −5.9 |
| physical | Tanδ(at 0° C.) | 0.898 | 0.871 | 0.878 | 0.729 |
| property | Tanδ(at 70° C.) | 0.097 | 0.092 | 0.098 | 0.121 |
| wear | wear loss(g) | 0.134 | 0.157 | 0.148 | 0.249 |

*SBR1721: styrene-butadiene copolymer (Kumho Petrochemical)

As noted in table 3 above, when used as a tire tread material, the inventive composite obtained by mixing the end-modified copolymer with silica is excellent in processability, a tensile property, a dynamic physical property and a wear resistance property. Especially, it was significantly excellent in wet-skid resistance (tan δ, 0° C.) and rolling resistance properties (tan δ, 70° C.).

As described above, in the styrene-butadiene copolymer, represented by Formula 2 above, end-modified with the hydrophilic chain transfer agent represented by Formula 1, the polymer synthesis with a high yield can be performed due to stable emulsion formation during emulsion polymerization.

Also, the inventive copolymer has a high affinity with a silica inorganic material. Thus, a silica composite including the copolymer and the silica material can replace various rubber materials. Herein, the composite can maintain the rubber's own high physical properties while highly improving dynamic physical properties such as wet-skid resistance, rolling resistance property, etc.

Accordingly, the present invention can be usefully used as a rubber material in the manufacturing field of rubber products such as a tire, a sole, a rubber hose, or a rubber belt.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A hydrophilic chain transfer agent represented by Formula 1 below: 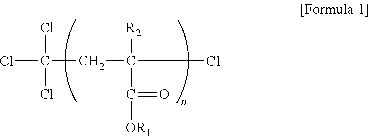
wherein In Formula 1, R₁ represents a hydrogen atom, a C1 to C8 straight, branched, cyclic alkyl group, a C1 to C8 hydroxyalkyl group, a C2 to C8 alkoxyalkyl group, or a benzyl group; R₂ represents a hydrogen atom, or a C1 or C3 straight, branched alkyl group; n represents an integer of 1 to 4,000.

2. The hydrophilic chain transfer agent as claimed in claim 1, wherein R₁ represents a C1 to C8 straight alkyl group, and R₂ represents a hydrogen atom or a C1 or C3 straight alkyl group.

3. The hydrophilic chain transfer agent as claimed in claim 1, which has a weight-average molecular weight ranging from 1,000 to 500,000 g/mol.

4. The hydrophilic chain transfer agent as claimed in claim 1, which has a weight-average molecular weight ranging from 1,000 to 20,000 g/mol.

5. An end-modified styrene-conjugated copolymer represented by Formula 2 below: 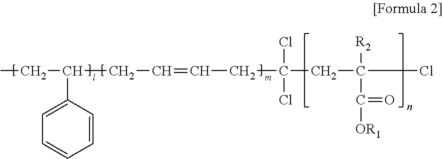
wherein in Formula 2, R₁ represents a hydrogen atom, a C1 to C8 straight, branched, cyclic alkyl group, a C1 to C8 hydroxyalkyl group, a C2 to C8 alkoxyalkyl group, or a benzyl group; R₂ represents a hydrogen atom, or a C1 or C3 straight, branched alkyl group; and t+m=1, wherein t represents an integer of 0.15 to 0.5, and n represents an integer of 1 to 4,000.

6. The end-modified styrene-conjugated copolymer as claimed in claim 5, which has a weight-average molecular weight ranging from 100,000 to 3,000,000 g/mol.

7. An organic-inorganic composite comprising: 100 parts by weight of end-modified styrene-conjugated copolymer as claimed in claim 5; and 50 to 90 parts by weight of silica.

8. The organic-inorganic composite as claimed in claim 7, which is used for manufacturing rubber products such as a tire, a sole, a rubber hose, or a rubber belt.

9. An organic-inorganic composite comprising: 100 parts by weight of end-modified styrene-conjugated copolymer as claimed in claim 6; and 50 to 90 parts by weight of silica.
